(19) United States
(12) Patent Application Publication
(10) Pub. No.: US 2015/0324940 A1
(43) Pub. Date: Nov. 12, 2015

(54) 3D Interactive Construction Estimating System

(71) Applicant: Modular North America, LLC, Santa Ana, CA (US)

(72) Inventors: Jeffrey S. Samson, Irvine, CA (US); Nak Young Sung, Anaheim, CA (US); Nana Wong, Arcadia, CA (US)

(21) Appl. No.: 14/706,573

(22) Filed: May 7, 2015

Related U.S. Application Data
(60) Provisional application No. 61/990,055, filed on May 7, 2014.

(51) Int. Cl. G06Q 50/16; G06Q 10/08; G06Q 30/06; G06F 17/50; G06Q 10/06

(52) U.S. Cl. CPC G06Q 50/16; G06F 17/5004; G06Q 10/06313; G06Q 30/0621; G06Q 10/0875

(57) ABSTRACT

A 3D interactive construction estimating system is provided that includes a computerized interactive ERP/3D design and estimating system for building construction projects and services. The computerized 3D interactive construction estimating system is real-time, visual, and transparent to both the customer and the manufacturer, and allows the customer to design and customize a home or other building with real-time integrated 3D virtual tour, pricing, scheduling, ordering, and financing options. The system includes an ERP system, a CAD system, and a graphical front end that provides the user with a virtual design experience.

### CROSS-REFERENCE TO RELATED APPLICATIONS

This application claims the benefit of U.S. Provisional Application No. 61/990,055, filed May 7, 2014 the entire disclosure of which is hereby incorporated herein by reference.

### FIELD OF THE INVENTION

The present invention relates generally to a 3D interactive construction estimating system, and more particularly, to a computerized interactive ERP/3D design and estimating system for building construction projects and services.

### BACKGROUND OF THE INVENTION

The global economy has made the business of selling more competitive than ever. Businesses that do not maximize customer satisfaction and profitability will not survive in today's markets. Businesses are therefore demanding tools and methods to provide a competitive edge.

Construction projects are historically human-intensive projects. This is especially true for customized home or other building construction. Typically, a customer looking to build a new home will meet with sales staff to choose a basic house plan, and will then proceed to customize that house plan to their specifications. The task of customizing the home is typically a lengthy and involved process in which the sales staff must manually step through each option with the customer. Often, this is done in hard-copy paper form, or may be partially computerized, but in any event that is generally opaque to the customer. For example, the customer typically will have to imagine or otherwise guess as to what the options will visually look like, especially if those options are different than the local model home. Additionally, the customer typically has no idea how each option will affect the overall pricing of the home.

Moreover, the construction company or manufacturer typically cannot track the real-time inventory, availability, pricing, manufacturability, or raw material costs associated with building customization. Instead, these values are typically estimated and reconciled later. Thus, although building customization inherently includes a wide array of variables, the construction company or manufacturer must use average or estimated values and timetables in the hope that these land close to reality.

The instant application solves all of the foregoing problems by providing a computerized 3D interactive construction estimating system for building construction projects and services that is real-time, visual, and transparent to both the customer and the manufacturer.

It is to be understood that both the foregoing general description and the following detailed description present example and explanatory embodiments of the invention, and are intended to provide an overview or framework for understanding the nature and character of the invention as it is claimed. The accompanying drawings, photographs, and attachments are included to provide a further understanding of the invention and are incorporated into and constitute a part of this specification. The drawings illustrate various example embodiments of the invention, and together with the description, serve to explain the principles and operations of the invention.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a method is provided for customizing a pre-designed tangible building to be physically constructed by a builder for a user, using a digital computer with a display. The method comprises the steps of receiving, using the digital computer, input from the user selecting a building template from a predetermined list of available building templates and displaying, upon a graphical user interface of said display of the digital computer, a virtual representation of the selected building template and an associated initial price of the selected building template. The method further comprises the steps of providing the selected building template with at least one interior or exterior feature that is customizable by the user, and receiving, using the digital computer, input from the user selecting a first customization option from a predetermined list of customization options that alters the selected building template with said at least one interior or exterior feature. The method further comprises the step of retrieving, using the digital computer, a first data element based upon computer-readable data stored in a Computer Aided Design (CAD) database that enables the digital computer to provide the user with a virtual representation of the selected first customization option. The method further comprises the steps of displaying, upon the graphical user interface of said display, a modified virtual representation of the selected building template that includes said virtual representation of the first selected customization option, and retrieving, using the digital computer, a second data element based upon computer-readable data stored in an Enterprise Resource Planning (ERP) database that represents a first unit price of the selected first customization option. The method further comprises the step of displaying, upon the graphical user interface of said display, a modified price that includes the initial price of the selected building template and the first unit price of the selected first customization option. The modified virtual representation and the modified price of the selected building template are displayed substantially at the same time. The method further comprises the step of assembling, using the digital computer, an engineering bill of materials to physically construct the pre-designed tangible building that includes the selected first customization option.

In accordance with another aspect of the present invention, an interactive system is provided for facilitating customization of a pre-designed tangible building to be physically constructed by a builder for a user. A Computer Aided Design (CAD) database stores a plurality of available building templates and further storing a plurality of first data elements each corresponding to one of a plurality of customization options that will alter at least one interior or exterior feature of the available building templates. An Enterprise Resource Planning (ERP) database stores computer-readable data that comprises an initial price for each of the plurality of available building templates and a plurality of second data elements corresponding to a unit price for each of the plurality of customization options. A common information database is distinct from and in communication with the ERP database and the CAD database. The common information database stores computer-readable data that comprises a plurality of product assemblies with each product assembly corresponding to one of the plurality of customization options, and each product assembly further comprises one of said first data element and one of said second data element. A tangible, interactive computer system is operated by the user, comprising at least one digital processor, at least one display connected to the at least one digital processor and capable of displaying a graphical user interface, a user touch-sensitive input device connected to the at least one digital processor for manipulating the graphical user interface based upon inputs received from the user, and a processor-readable storage device. The processor-readable storage device includes instructions executable by the at least one digital processor to execute instructions for receiving, using the touch-sensitive input device, input from the user selecting a building template; displaying, upon the graphical user interface of the display, a virtual representation in three dimensions of the selected building template and an associated initial price of the selected building template; receiving, using the touch-sensitive input device, input from the user selecting one of said plurality of customization options; and receiving, from the common information database, a product assembly that corresponds to the selected customization option and includes associated first and second data elements. The first data element of each of the plurality of customization options comprises computer-readable data that enables the at least one digital processor to display in three dimensions a virtual representation of each customization option upon the at least one display. The processor-readable storage device further includes instructions executable by the at least one digital processor to execute instructions for displaying, upon the graphical user interface of the display, a modified virtual representation in three dimensions of the selected building template that includes said virtual representation of the selected customization option based upon said associated first data element; and displaying, upon the graphical user interface of the display, a modified price that includes the initial price of the selected building template and a unit price of the selected customization option based upon said associated second data element.

It is to be understood that both the foregoing general description and the following detailed description present example and explanatory embodiments of the invention, and are intended to provide an overview or framework for understanding the nature and character of the invention as it is claimed. The accompanying drawings are included to provide a further understanding of the invention and are incorporated into and constitute a part of this specification. The drawings illustrate various example embodiments of the invention, and together with the description, serve to explain the principles and operations of the invention.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a flow diagram of the overall system and methodology of the subject matter herein;

FIG. 2 illustrates one example computerized system architecture;

FIG. 3A illustrates a schematic overview of an example physical design facility;

FIG. 3B illustrates an example design suite located within the physical design facility;

FIG. 4 illustrates an example graphical user interface (GUI) for use with a real-time virtual home design experience;

FIG. 5 illustrates an example exterior customization feature for the real-time virtual home design experience;

FIG. 6 illustrates an example interior customization feature for the real-time virtual home design experience;

FIG. 7A illustrates a detail view of a portion of the interior customization feature with a first set of customizations; and

FIG. 7B is similar to FIG. 7A, but illustrates a second set of customizations.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

The present application relates generally to a 3D interactive construction estimating system, and more particularly, to a computerized interactive ERP/3D design and estimating system for building construction projects and services. The computerized 3D interactive construction estimating system for building construction projects and services that is real-time, visual, and transparent to both the customer and the manufacturer. In a short and non-limiting summary, the interactive design system allows customers to design and customize a new home or other building, with real-time integrated 3D virtual tour, pricing, scheduling, and ordering.

While the following description of the 3D interactive construction estimating system will be explained by way of an example home construction project, and in particular a modular home construction project, it is understood that the system can apply to the entire construction industry as a whole and can be used with any type of construction project. For example, other types of construction projects can include other residential buildings (apartments, condominiums, multi-family homes), commercial buildings, industrial buildings, storage facilities, etc. Moreover, the interactive design system could apply to any other construction project that may or may not involve human habitation, such as utility projects, municipal projects, capital improvement projects, etc.

In one example described herein, prospective homebuyers who intend to purchase and build a new home within a community in development will be able to make custom selections regarding the home, including: architecture and room layout, landscaping, interior/exterior finishes, interior/exterior design, furniture, furnishings, lot location, facing direction, and more. Once the custom selections have been made, the prospective homebuyer will receive an automated price list, and they will be able to preview their home virtually, prior to making the final purchase and obtaining financing, which will also be available on-site. This is a summary of everything that happens in the Design Studio described below, but these same capabilities and sales tools will be available on any touch screen remote or mobile device (including tablets, desktop computers, and mobile smart phones) with authorized access.

As will be appreciated by one skilled in the art, the present application may be embodied as a system, method or computer program product, and may take the form of an entirely hardware embodiment, an entirely software embodiment or an embodiment combining software and hardware. Furthermore, the present application may take the form of a computer program product embodied in any tangible storage medium of expression having computer-usable program code embodied in the medium. By computerized, it is meant that the functions, steps, or tasks described or illustrated herein are preferably performed by a programmed digital microprocessor executing instructions stored in or on a computer readable storage medium. One of ordinary skill in this art will recognize that the functions, steps, or tasks are independent of the particular type of instruction set, storage medium, microprocessor, or processing strategy and may be performed by software, hardware, integrated circuits, firmware, microcode, and the like, operating alone or in combination. Computerized systems can include various computing devices such as general purposes computers or laptop computers, mobile phones, tablets, PDA's, embedded systems, virtual reality systems, workstation computers and/or server computers, any of which can run a variety of commercially available operating systems. Other example computing devices can include televisions, kiosks, or other large-format screen-based devices that include computerized functions, thin-client computers, personal messaging devices, or other similar devices that can communicate over a network. With regard to server computers, these may be general purpose computers, specialized server computers, mainframe computers, rack-mounted servers, server farms, server clusters, or any other appropriate arrangement and/or combination. Any of these systems can operate in regular or virtualized environments. Likewise, processing strategies may include multi-processing, multi-tasking, parallel processing, and the like without departing from the spirit or scope of the present application.

The associated computer hardware elements may include one or more central processing units (CPU), one or more input devices (e.g., a mouse, a keyboard, touchscreen, digitizer, touch or touchless gesture-based input, camera-based input, etc.), and one or more output devices (e.g., a display device, virtual reality device, a printer, etc.). Computer readable storage media may include various types of volatile and non-volatile storage media including but not limited to random access memory (RAM), read-only memory (ROM), programmable read-only memory (PROM), electrically programmable read-only memory (EPROM), electrically erasable read-only memory (EEPROM), flash memory, magnetic tape or disk, optical media, and the like.

Data transmission and/or reception may occur locally within a single computer device or one or more virtualized computing devices, or may even occur between two or more networked computer devices, using wired or wireless systems, via a local area network (LAN) and/or wide area network (WAN, or more often generally referred to as “the internet”). Those of skill in the art will understand that networking systems can support data communications using any of a variety of commercially-available protocols, including suitable wired and/or wireless network systems and protocols.

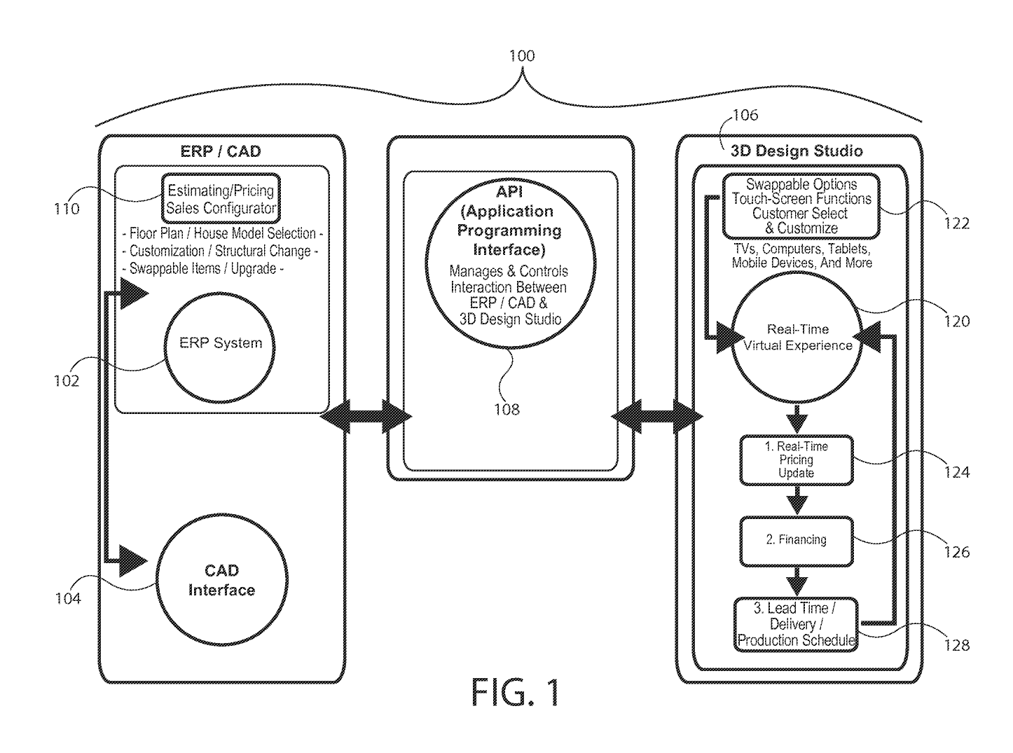

Turning to the example of FIG. 1, a schematic flow diagram 100 illustrates the overall system and methodology of the subject matter herein. The computerized system of the instant application provides a real-time integrated solution that includes a plurality of major components that interface over a communication network, including: an Enterprise resource planning (ERP) system 102; a CAD system 104 (i.e., a computer automated design system) that provides an Engineering resource system; a 3D Design Studio 106 that provides a user with a real-time virtual experience based upon data provided by the ERP and CAD systems; and an application programming interface (API) 108 that provides the integration layer between the 3D design studio and the ERP and CAD systems. The 3D design studio 106 is a graphical front-end that is layered on top of the ERP system 102 and CAD system 104 to provide a user input and output system, and the API 108 manages and controls the interaction between the ERP/CAD systems and the 3D design studio.

The enterprise resource planning (ERP) system 102 includes any computer-based system or architecture that is adapted to facilitate the flow of information between business functions. An ERP system typically includes business management software, including one or more integrated applications that a company can use to store and manage data from different stages of business. Some of these stages may include: Product planning, cost and development; Manufacturing; Raw material costs; Marketing and sales; Inventory management; Purchasing management; Production scheduling; Sales order processing; Distribution; Job costing; Labor information; Geographical cost adjustments; Shipping and payment; and Financial accounting.

ERP systems provide an integrated real-time view of core business processes, using common databases maintained by a database management system. ERP systems often employ one or more connected databases and a common computing platform to consolidate business operations into an enterprise wide system environment. Example tasks facilitated by certain ERP systems include managing internal and external resources, including accounting, material, and human resources. In some examples, ERP systems track business resources, such as cash, raw materials, production capacity, scheduling, etc., as well as the status of business commitments, such as orders, purchase orders, and payroll. Multi-tier ERP software and hardware can enable a company to run the equivalent of two ERP systems at once, such as one at the corporate level and one at the division or subsidiary level, and may further enable web-based software that provides remote real-time access to ERP systems to employees and partners (such as suppliers and customers). As used herein, a database can be any collection of data.

In the instant example, the ERP system 102 can be tailored for use in various construction projects, such as residential home construction projects (single family homes, modular homes, cluster homes, condos, apartments) or even industrial, or commercial building construction. In one example, the ERP system can include functionality to manage all of the manufacture of the physical housing structure, modifications to the physical housing structure, selection and placement of interior elements of the modular home and customizations or upgrades to the interior elements of the modular home. The ERP system can provide estimated pricing and availability of these items, as well as sales configuration tools. For example, the ERP system can include information relating to: Inventory/Purchasing; Manufacturing; Production Scheduling; Sales Order Processing; Distribution; Job Costing; Financial; and Accounting.

Additionally, when used in the construction industry the ERP system can include, or can be connected to, an Estimating/Pricing Sales Configurator 110. This can include data related to Floor Plan/House Model Selection; Customization/Structural Changes; and Swappable Items/Upgrades. For example, when used in the sales process of a modular home, the ERP system can manage the variations of housing model, floor plans, and structural changes thereto. Examples can include room dimensions, wall placement, wall height, pitch of the roof, window placement and selection, etc. Going further, the ERP system can manage swappable items, customizations, upgrades, etc. Examples can include flooring types, wall colors or features, cabinet selection, outlet placement, kitchen options, bathroom options, etc. Due to its computerized nature, the ERP system can manage the sales process of a home construction in a real-time, transparent manner for both of the customer and the sales agent. With each item selected or changed, the ERP system can quickly enable (preferably in real-time) estimated pricing, scheduling, availability, and conflict management. This system can further convert the final, customized home into a production plan or manufacturing plan. The system may further handle the management and ordering of basic building materials, including wood, steel, fasteners, roofing, plumbing, electrical, insulation, concrete, windows, doors, landscaping, etc.

As noted above, the computerized system further includes an Engineering resource system (including 3D CAD system). While the ERP system can manage and track the pricing, scheduling, materials, etc. of the project, the Engineering resource system can manage the structural configuration of the physical component parts. The Engineering resource system preferably includes a three-dimensional, computer-aided design system that is capable of assisting in the creation, modification, analysis, or optimization of a home design. Additionally, the Engineering resource system may further be configured to perform strength and dynamic analysis of a home design, per local standards, and may be configured to include or address building codes (national and/or local). Preferably, the Engineering resource system may utilize a customer's chosen design to further assist in the resulting manufacturing process, especially in the manufacture of a modular home, and ultimately in the on-site building process. Because most potential home purchasers are not architects or engineers, the Engineering resource system preferably is configured in such a manner as to provide customer self-design features with guided-help procedures so that a customer cannot design a home that is not available, structurally impossible, against building codes, etc. For example, although the system may appear to allow the customer complete control over the home design, the Engineering resource system may in reality only permit the user to make selections or adjustments from a predetermined, finite number of selectable options. Additionally, the Engineering resource system can output various information, such as materials, processes, dimensions, and tolerances, according to suitable conventions of the home building industry.

The real-time integrated solution of the instant application combines the power of an ERP system together with an Engineering resource system, and further provides the customer/end user with an easy-to-use graphical front-end that provides a user input and output system. The graphical front-end can be tailored to a specific environment or application based upon the sales environment of the customer. The graphical front-end is referred to herein as the 3D design studio 106, and provides the user with a number of input and output features. The core of the 3D design studio 106 is the real-time virtual experience 120, which provides the user with a real-time graphical display of a virtual building corresponding to the real-world building that the customer is intending to purchase and have built.

In concert with the real-time graphical display, the 3D design studio 106 further provides the user with customization engine 122 that presents the user with all of the available swappable options for the particular building so that the user can select and customize the building, including interior features, exterior features, land features, etc. Additionally, the 3D design studio 106 provides the customer with real-time pricing 124 of the building, based upon all of the various customizations and design changes selected by the user via the customization engine 122. Next, once the customer has finalized the design of their home, the 3D design studio 106 can further provide a financing engine 126 to handle the customer's contractual and financial obligations to pay for the real-world building. Lastly, the 3D design studio 106 can provide a production engine 128, which can facilitate the lead time, delivery, and/or production schedule for constructing the customized real-world building.

The application programming interface (API) 108 provides the integration layer between the 3D design studio and the ERP and CAD systems to thereby manage and control the interaction between the ERP/CAD systems and the 3D design studio. Generally speaking, in computer programming, an API is a set of routines, protocols, and tools for building software applications. An API provides the building blocks for a computer program, which are put together by a programmer. An API defines functionalities in terms of its operations, inputs, outputs, and underlying types that are independent of their respective implementations, which allows definitions and implementations to vary without compromising each other. In addition to accessing databases or computer hardware, such as hard disk drives or video cards, an API can ease the work of programming GUI components. APIs often come in the form of a library that includes specifications for routines, data structures, object classes, and variables.

In the instant application, the API 108 manages and controls the interaction between the ERP and CAD systems 102, 104, and the 3D design studio 106. The API can be designed to function with a specific ERP, CAD, and graphical visualization system, or preferably, can provide an open platform that can provide intelligent integration with substantially any specific ERP, CAD, and graphical visualization system. As can be imagined, different architects, design companies, construction companies, manufacturers, etc. will have and utilize various ERP and CAD systems, which are likely to be different from each other. Similarly, there are many graphical visualization systems and implementations that can utilize the data from the ERP and CAD systems to provide a user with a real-time virtual experience. Thus, the API described herein provides an effective “bridge” to enable a computer programmer to efficiently and effectively connect between a company's ERP and CAD systems, and a desired graphical visualization system for a user. The instant API is described as a 6D Building Information Modeling (BIM), which refers to the intelligent linking of individual 3D CAD components or assemblies with all aspects of project life-cycle management information. The term “6D” is derived from the following: “3 dimensional design”+Time+Cost+Manufacturer Information=6D BIM. 6D BIM Information (including all relevant building component information, such as product data and details, maintenance/operation manuals, cut sheet specifications, photos, warranty data, web links to product online sources, manufacturer information and contacts, etc.) can be delivered to the home or property owner.

In the instant application, the 3D design studio 106 (via the real-time virtual experience 120) is capable of outputting various virtual representations and visualizations of the building in three dimensions and in real time, including solid models, photo realistic rendering, floor plans, blueprints, videos, etc. Additionally, the system is configured to provide a virtual walk-through of a home design that allows zooming-in or out, movement, and rotation in three dimensions that allows viewing of a designed home from any desired angle, and even from the inside looking out or outside looking in. Preferably, the system further allows for an exploded view of various components, so that the customer can better view, understand, or customize the sub-components. As will be described more fully herein, the real-time virtual experience 120 of the 3D design studio 106 is preferably part of a physical sales office or facility, and is performed in a dedicated space specifically designed to best facilitate the custom design of a home or other building. Still, in a more simplified system, the graphical front-end can be configured for use on a stand-alone computer or laptop, such as from a customer's home. Similarly, the graphical front-end can be alternatively configured for use on a mobile tablet, phone, or similar device. In other alternatives, the graphical front-end can be configured for use in various virtual reality systems, including head-mounted displays, holographic displays, projected displays, etc. Each configuration of the graphical front-end can be adjusted per the inherent abilities and constraints of the device.

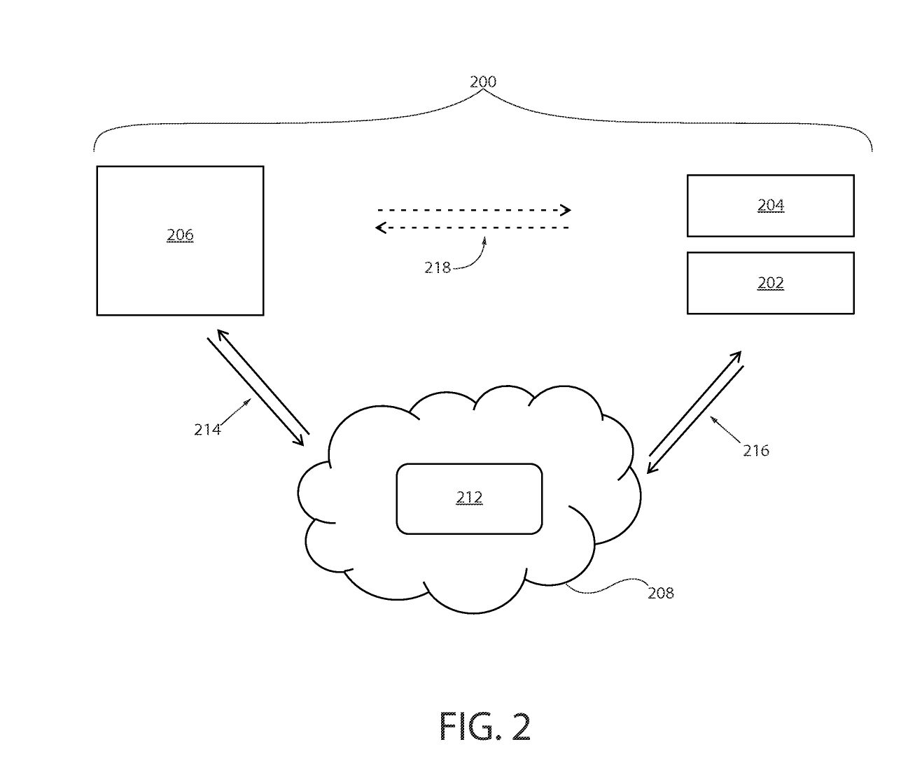

Turning now to FIG. 2, one example computer system architecture 200 illustrates data flow among the various components of the interactive construction estimating system. In this system architecture 200, the API 208 provides a bridge between the ERP system 202 and CAD system 204 on the one side, and the graphical front-end design studio 206 on the other side. The API 208 provides a “middleware” software that connects the enterprise applications 202, 204, 206 via core services like concurrency, transactions, threading, messaging, etc. In this regards, the API 208 middleware can enable uni-directional or bi-directional communication and access to a shared common information database 212 that is accessible by any or all of the ERP system 202, CAD system 204, and graphical front-end design studio 206. The common information database 212 is especially useful for providing real-time construction data and product availability, as well as real-time pricing to the customer as part of the real-time virtual experience. For example, it is contemplated that as the customer is actively customizing a new home or building in real time, the system architecture 200 is designed to provide real-time pricing to the user so that the immediate cost and effect of each customization can be experience by the user. In this regards, the user can quickly and efficiently understand the actual price effect of each choice made during the home design process.

In order to enable the real-time pricing feature, the system architecture 200 leverages the common information database 212 to enable the communication of data between the graphical “front-end design” studio 206 (the “virtual experience” of the user), and the supporting “back-end” ERP system 202 and CAD system 204. In practice, the system will operate for the user in real-time to visually show the user the customized home with the selected options, and with updated pricing information. In order to provide this presentation and speed, the ERP will have already pre-populated the relevant information regarding the home and customization options, and the CAD system will have pre-rendered the virtual representations of the home and customization options. This prepared information will be stored in the common information database 212 for ready and quick access. In the example shown in FIG. 2, bi-directional information exchange 214 can be allowed between the design studio 206 and the common information database 212, so that the virtual experience of the design studio 206 can request and receive pricing information contained within the common information database 212 for display to the customer. In order to supply and populate this pricing information, bi-directional information exchange 216 can be allowed between the supporting ERP and CAD systems 202, 204 and the common information database 212. In this regard, changes to the pricing of customizable or swappable options (based upon many factors, such as component cost, labor cost, transportation cost, overhead costs, etc.) that are entered, maintained, and/or calculated within the ERP system 202 will then be reflected within the common information database 212 for retrieval by the virtual experience of the design studio 206. Based upon this flexibility, each of the overall system components can be effectively compartmentalized for operational and maintenance efficiency, but can easily interoperate with each other via the API 208 and the shared common information database 212. Moreover, compartmentalization of the various system components enables some or all of these components to be located at different physical locations, and be connected to each other via a networked computer environment. In one example, the common information database 212 can be provided as server-connected storage (e.g., local or “cloud” storage), which all of the ERP and CAD systems 202, 204 and design studio 206 can be permitted access to. In this regard, the common information database 212 can act as an intermediary server-connected storage to maintain operational communication between the ERP and CAD systems 202, 204 at one physical location, and the design studio 206 at another physical location. Indeed, under this scheme, the ERP and CAD systems 202, 204 could be at different physical locations.

Additionally, due to the compartmentalization of the data within each of the component parts (ERP and CAD systems 202, 204, design studio 206 and common information database 212), different types and collections of data can be maintained, collected, and/or presented as might be effectively used by each component. For example, highly detailed information about each component used to construct a house or building can be maintained within the ERP system, without regard to CAD data. Similarly, highly detailed construction design information can be maintained by the CAD system, including 2D and 3D drawings, material specifications, design algorithms, construction or legal code information, etc. without regard to cost or pricing information. However, the design studio 206 may not necessarily need such highly detailed information about sub-component pricing or engineering details in order to provide the virtual experience to the user. Instead, the design studio 206 may function more efficiently through the use of product assemblies that are pre-calculated for quick and ready access. A product assembly is a single part representation with a single set of engineering features, and may further include a single price or other attribute(s). Each product assembly is formed of a combination of sub-parts, and represents a sum of all of the engineering features and/or sub-component prices. In one example, a single kitchen cabinet assembly may be formed as a collection of its sub-component parts, such as the cabinet box, cabinet door(s), hinges, door pulls, mounting hardware, other features, etc. Each of these sub-component parts can have its own engineering data (prepared 2D drawing, pre-rendered 3D drawing, dimensions, physical features, materials, performance data, unique installation requirements, etc.) maintained by the CAD system 204, and pricing data (manufacturer cost, labor cost, overhead, adjustment factors, suggested retail price or mark-up factor, etc.) maintained by the ERP system 202.

Each product assembly, as a single whole assembly, can be maintained by the common information database 212 for retrieval by the design studio 206. Thus, when a single cabinet assembly is accessed by the design studio 206, one overall set of engineering data and one price can be quickly and easily retrieved from the common information database 212 and incorporated into the virtual experience for the user. As a result, the user can quickly see the effect of changing between “cabinet option A” and “cabinet option B,” each with its own certain features, appearance, and price. At the same time, if any of the data points of each sub-component part changes, such as a price change of a sub-component part, these changes can be entered into the ERP system 202 and can be quickly reflected, possibly in real-time, in the overall whole assembly maintained by the common information database 212. The overall effect of this compartmentalized, integrated approach is that the attributes of each sub-component can be quickly and easily updated in the ERP system as they occur, and those changes can be similarly easily reflected in the common information database 212, while being seamless to the end user participating in the real-time virtual experience. Each assembly can have its own unique ID code. A complete list of the chosen assemblies used in the final home design can be maintained, and ultimately the ERP system can be used to tally all of the chosen assembly codes to provide complete pricing and a bill of materials for the entire, finalized home.

As noted above, the information exchange 214, 216 enabled by the API 208 middleware can be uni-directional or bi-directional with the shared common information database 212. The uni-directional or bi-directional communication can be controlled as known by one of skill in the art, such as by permissions, program controls, etc. The information exchange 216 between the common information database 212 and ERP system 202 and CAD system 204 can occur in either direction, but preferably changes to the ERP system 202 and/or CAD system 204 are “pushed” downward to the common information database 212, either in real-time or on a pre-set schedule (i.e., each hour, each day, etc.) to synchronize and provide a highly up-to-date database. In another optional workflow, the common information database 212 could be designed to periodically request an update from each of the ERP system 202 and CAD system 204 based upon a pre-set schedule (i.e., each hour, each day, etc.) to provide a highly up-to-date database. Similarly, the information exchange 214 between the common information database 212 and the graphical front-end design studio 206 can occur in either direction, but preferably the design studio 206 will request certain information from the common information database 212 on an as-needed basis. For example, each time data is needed about a particular component part (e.g., a cabinet assembly, door, window, or other constructions feature), such data will be communicated on-demand to the design studio 206 to thereby provide the real-time virtual experience to the end user. It is contemplated that each data request made to the common information database 212 for an assembly can retrieve only that assembly, or may alternatively retrieve the requested assembly together with related swappable options. In this manner, the design studio 206 can pre-cache the various swappable options locally in an effort to make the experience operate more quickly to the end user as they wish to navigate among the different options and combinations. Alternatively, it is contemplated that the design studio 206 could have direct communication 218 with either or both of the ERP system 202 and CAD system 204.

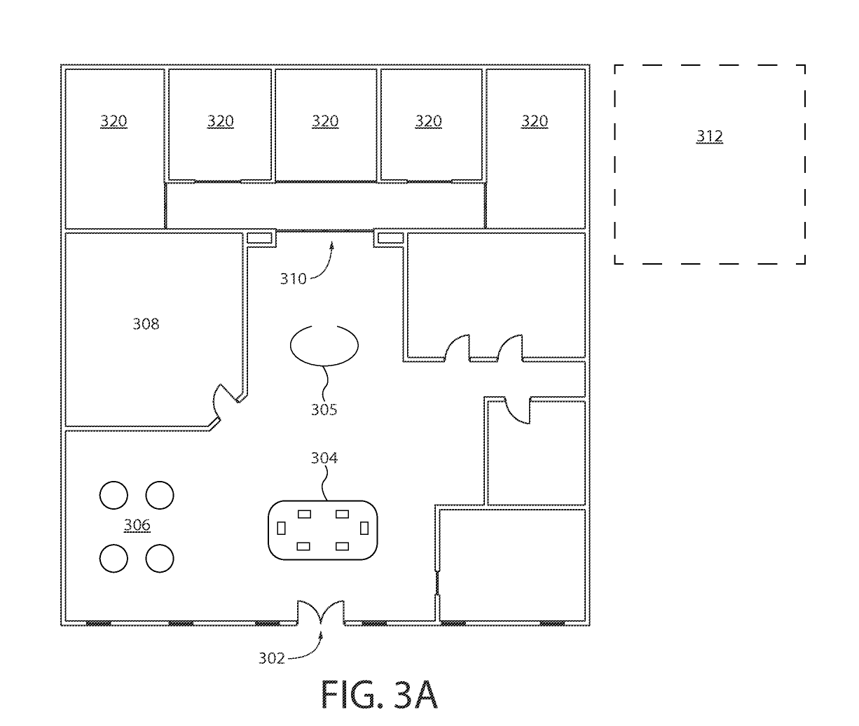

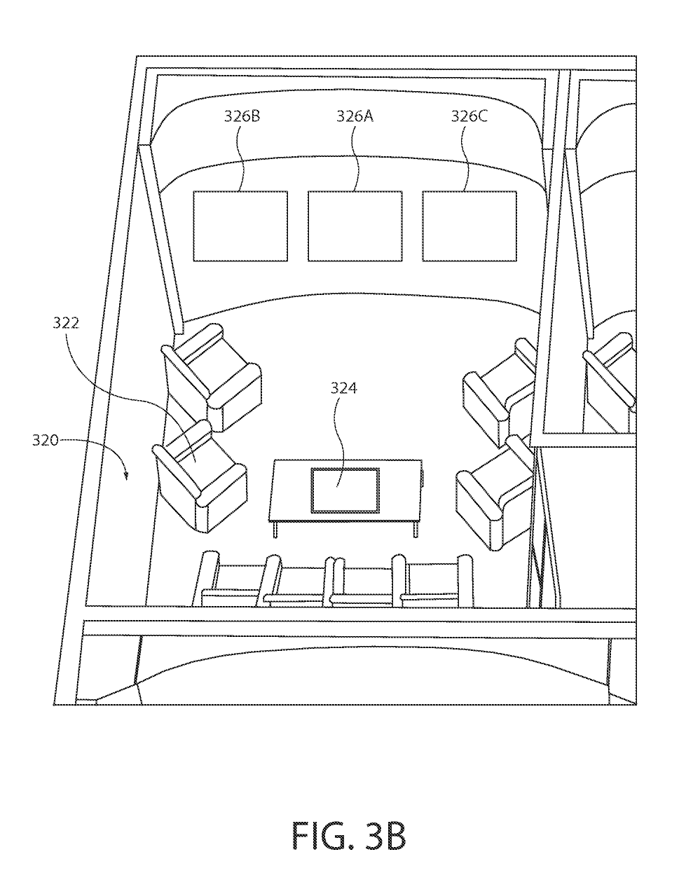

Various operational examples will now be described. Turning now to FIGS. 3A-3B, customers can customize their desired homes at a physical sales office 300, which may be referred to as a physical design facility. It is contemplated that the physical sales office 300 can take on many forms and sizes, and will be tailored to fit the particular type of real estate being sold (e.g., single family homes, cluster homes, condos, apartments, commercial, industrial, etc.). As shown in FIG. 3A, one example physical sales office 300 may be approximately 90′×90′ with 15′ ceilings. The sales process is streamlined and effective. Preferably, models of the actual homes or other buildings are adjacent to the sales office, adding to the abundant audio, visual, and tactile sensations for an extremely smooth and satisfying home-buying and sales experience. Banking partners are located on-site or nearby, as well, to efficiently finalize the experience.

The example physical sales office 300 will now be described. Customers will enter the sales office 300 at the entry 302 and will proceed into the welcome area 304 to be greeted by members of the sales team. The welcome area 304 may include a map or possibly a physical model of the housing development, and may further include one or more displays (touchscreen or non-touch) providing additional information about the housing development and available housing options. Preferably, touchscreens will be used to foster an interactive environment. A help desk 305 may also be provided to help the customers with their various needs. Nearby is a touchscreen area 306 (or other information display area), where customers are encouraged to physically touch the screens to peruse the home offerings in the touchscreen area (e.g., 2-10 screens are contemplated, although more or less can be used). The touchscreens may be mounted on the wall, on tables, on kiosks, etc. Other non-touch screens and other information systems can be presented. Here, the customers are shown the available model homes and the phases of development of the homes on each site. Via the touchscreens, the customers are free to browse and can look into more details to see what homes have been sold or not sold. TV screens are installed across the surrounding walls, and all of those walls may further have touchscreens. Wireless headsets may be available next to each TV. Visitors will be able to select a language, put on the headset and be guided through the offerings. There may also be a physical display board where customers may touch the products. In addition, there may be provided a movie theater 308 where the customers can first see a video/slide show presentation that includes a demonstration of the production process, the set of the homes, and their finished appearance at the home site. If the construction technique includes modular home building, the video/slide show presentation may also include a virtual tour of the home-building factory, which will explain the benefits of modular building. The physical sales office 300 may also offer various other additional features, such as a children's play area, refreshment area, restrooms, and help desk. The above features may be referred to as the public-access portion of the physical sales office 300.

Additionally, the sales office can include a private-access portion for customers who are serious about designing and purchasing a new home or other building. The private-access portion will be a secure access-controlled area 310, such as by using a key, key-card, access code, or the like. Preferably, prospective customers are admitted by appointment only. The access-controlled area 310 leads to the physical model homes and to the virtual Design Suites. For example, physical model homes 312 will be accessible beyond the access-controlled area 310, and are likely located adjacent to, but outside of, the physical sales office 300. Traffic in and out of the sales office 300 will be managed through specific doors, so the prospective customers return to the sales office 300 to exit altogether. In this manner, the prospective customers are able to view the model homes, and then return to the sales office 300 for further consultation with sales staff.

Next, the physical sales office 300 further includes a plurality of virtual design suites 320. In this example, four design suites 320 are shown, although there may be more or less. Preferably, each design suite 320 is located in a dedicated room so that the customer has a private and focused area to design their home. Here, the sales person brings the prospective customers to help them design the home and choose the lot they desire, through a rich, 3D virtual experience. A detailed view of one example design suite 320 is shown in FIG. 3B. A seating area 322 is provided in the design suite 320 for the customer and sales team member, and optional guests. A computer input area 324 is located nearby that will enable the customer or sales team member to input information related to the desired home/building and customizations. Preferably, the input area 324 includes at least one touchscreen device capable of receiving computer input based upon the physical touch of a person's hands, and also capable of acting as a computer display device. Still, various other input devices (computer keyboards, mouse/trackball, touchpad, digitizer pen, voice control, etc.) may be used together or in replacement of the touchscreen. At least one large format display is located on a wall opposite from the seating area 322. Preferably, the graphical front-end can be configured for use in a multi-display system, such as two, three, or more. In the shown example, three displays 326A, 326B, and 326C are used to present the customer with a graphical, virtual-model of the home that is actively being designed.

The system is designed to enable a user to select and customize different exterior or interior features of the home (within the bounds permitted by the manufacturer). The various items, features, and options of the house are preferably selectable by touch, and are capable of direct manipulation in real-time on the screen with regards to position, rotation, location, addition, deletion, exploded views, etc. In one example, the central or primary display 326A could show a virtual real-time 3D model and/or 2D floor plan of the house being designed by the customer, while the flanking left and right displays 326B, 326C could show different customizable/swappable options and associated prices, dimensions, etc. These secondary monitors can display detailed information about each item selected, such as detailed pricing and availability of the various components. Additionally, any available options or sub-options of the selected components can be displayed and adjusted on these displays. It is understood that changes and updates performed on this second touchscreen can be reflected and displayed in real-time (or possibly delayed until confirmed by the user) upon the 3D model and/or 2D floor plan shown on the central touchscreen. In other examples, two or more of the displays 326A, 326B, 326C could show a side-by-side comparison of a particular customizable/swappable option. For example, if designing a kitchen, the user may select from different surface finishes for the flooring, countertops, cabinets, and/or appliances. Some or all of the displays can simultaneously show the user multiple variants of their selection choices so that they can decide which combination of customizations they prefer. The multiple displays 324A, 324B, and 324C can show other various information, as will be described herein.

It is in these design studios 320 that the customer will participate in the real-time virtual experience 120 described herein. The customers will choose from various model homes, with or without the guide of the sales person. Once the customer has finished customizing the exterior of the building, the sales person will guide the customers in virtually moving through the interior of the home to customize the different rooms of the home. The customization of the home can include large structural items, or small detail items. For example, the sales person can display the home preferred by the customer, and show approximately three (or more/less) exterior options with various large structural options. Then, they will be shown approximately three (or more/less) different interior options for each home, with optional floor plans, wall placement, optional rooms, etc. Next, the sales person will present the home up room by room, showing the base model, features, and the finished model which will include customer-driven customizations and selections. Preferably, the sales office 300 design studio provides a touchscreen experience wherein each Design Suite will allow the customers and sales staff to scroll through the options and customize the home, including furniture, landscaping, electronics, “smart house” options, and solar panels, as desired.

Following customization of the home, full pricing will be provided for all aspects. Then, the customer will be guided through the virtual walk-through of the home, which includes aerial views how the sunlight will come through the windows at different times of the day and year based on the orientation of the house and lot. If the customer prefers not to purchase the home immediately, the selections and customizations of their virtually designed home will be saved locally and/or remotely, and may be provided to the customer via CD, flash drive, or server-connected storage (e.g., “cloud” storage) as desired, so they may consider the options at their leisure outside of the Design Studio.

Returning to FIG. 3A, if the customer decides to purchase the home during their visit, they will then proceed to the boardroom 340 where the homebuyer will receive a full contract and catalog, including details and warranties of all options they intend to purchase, including electronics, appliances, furniture, and other warranties. A banker or other financial service provided may be present in the boardroom, so that the homebuyer will know the exact payments, terms, and conditions of their new home.

One example home design process will now be described. This particular example will illustrate one manner of designing and purchasing a custom home, and in particular a modular home construction project, although it is understood that it may similarly apply to any other building or other project pertaining to the overall construction industry (single family homes, cluster homes, condos, apartments, or others). Additionally, this example will merely describe only one possible workflow, with the understanding that various possible workflows may be used with various steps, order of operations, visual depictions, input/output schemes, etc.

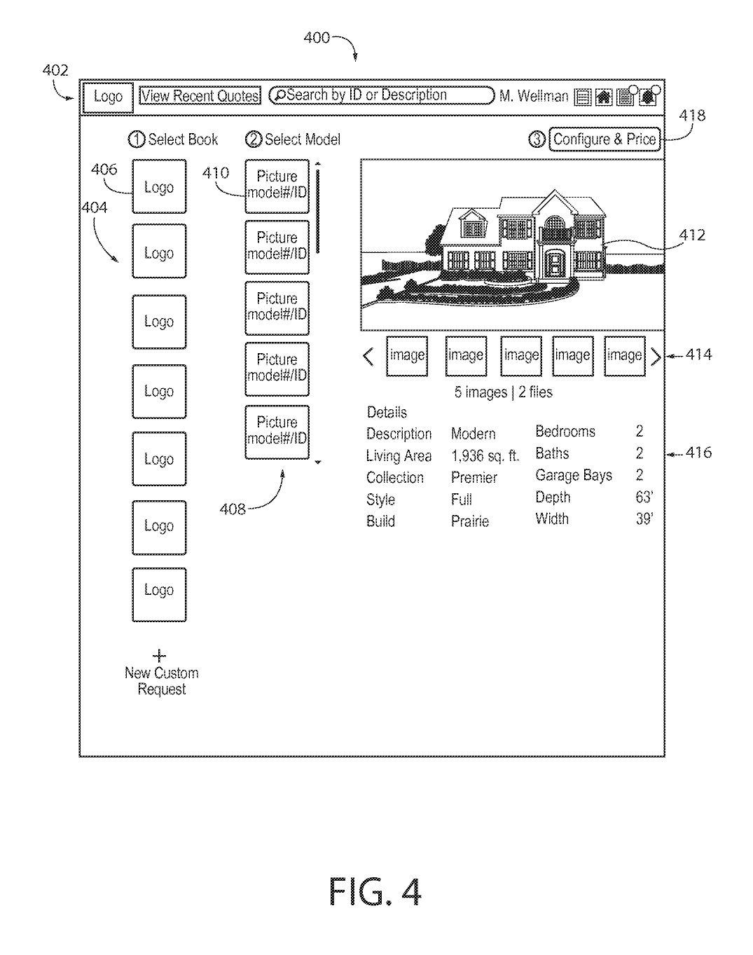

Turning now to FIG. 4, the user will utilize a graphical user interface (GUI) 400 to enter information into the system. The GUI is part of the real-time virtual experience 120 of the 3D Design Studio 106. In one example within the design suite 320, the GUI 400 may be presented upon the touchscreen of the computer input area 324, and/or may also be presented upon some or all of the multiple displays 324A, 324B, and 324C. Of course, the GUI can be adapted for the particular display and input being used (e.g., standalone computer, tablet, mobile phone, television, virtual reality, etc.). Additionally, it is noted that the following workflow using the shown GUI 400 may be presented in a template format to help guide the user through the process and enable only those features permitted by the sales team, builder, contractor, manufacturer, etc. The shown GUI 400 is presented in one example as an internet web page or portal, although it is understood that the GUI may be presented via whatever computer program or graphical front end is desired.

Initially, GUI 400 provides an introductory screen that may ask the user to log in to an account, or may be done via an anonymous account. Optionally, the system may permit the user to directly begin the building design without entering a login account. If the user has a unique login, then the user can be presented with a customized user option menu 402 that identifies them by name and allows the user to view recent or past designs that were saved in the system. This can allow a user to design their home over multiple sessions. The user's account and associated design information may be stored within the system, such as within the common information database 212, with the sales team or builder, locally upon a CD, flash drive, or server-connected storage (e.g., “cloud” storage). Upon login (or directly, if no login is used), the user can select a first collection 404 of home designs that are organized variously. In one example, each collection of homes may refer to different builders/manufacturers, locations, home developments, or to different types or styles of available homes. Various manufactures or builders are shown, and additionally the user may be provided options for a builders model, to copy a previous quote, or even to make a new custom request. The list is scrollable. In this example, the user selected a collection 406 from manufacturer All American Homes.

Next, the user can select from a predefined list 408 of available home models that can be constructed by the selected manufacturer or builder. Each of these home models is a pre-designed building template. The list 408 is scrollable and although the available homes are shown as a two-step list, it is understood that the home designs could be arranged in various multi-step lists or other organizational structure. In the shown example, the user selected the first model 410 in the list. Upon selecting a model, one or more pictures 412 of the selected model are shown to the user. Here, the picture 412 illustrates a front elevation of the selected home model. Additional corresponding information 414 is presented below the picture 412 in a scrollable format, such as engineering floor plans, secondary images of the home model, etc. The user is able to select any of this corresponding information 414 for an enlarged view. Further, corresponding home specifications 416 is presented below the picture 412, such as a written description of the home, model, square footage, style, number of rooms, number of baths, number of bedrooms, stories, garage bays, home dimensions (e.g., depth, width), base price, etc. The user can quickly select a different collection 404, home model list 408, and ultimately different home model 410 for view. Based upon this displayed information, the user has quick access to a number of available home plans for comparison purposes. Lastly, once a user has selected a desired home model to customize, the user can proceed by selecting a “Configure & Price” button 418.

The following examples describe various examples illustrating how a user can select one or more customization options from a predetermined list of customization options that alter the selected building template. Each room or space will have its own associated list of customization options that relate to interior or exterior features of the home. It is contemplated that the interior or exterior features may be attached to the home, or may be separable from the home. For example, the customization options can relate to attached items such as structural elements, cabinets, countertops, flooring, lighting, plumbing, electrical, communications, storage, landscaping, solar panels, as well as non-attached items such as appliances, furniture, furnishings, etc. In this regard, the customized home may be at least partially furnished when it is ultimately delivered to the user. Moreover, the customization options can further relate to the positioning of items inside or outside the home so that the user can customize the location/orientation of particular attached or non-attached items. For example, the user can customize the location/orientation of walls, cabinets, appliances, power or telecommunication outlets, etc., and/or may customize the location of purchased furniture, landscaping, solar panels, etc.

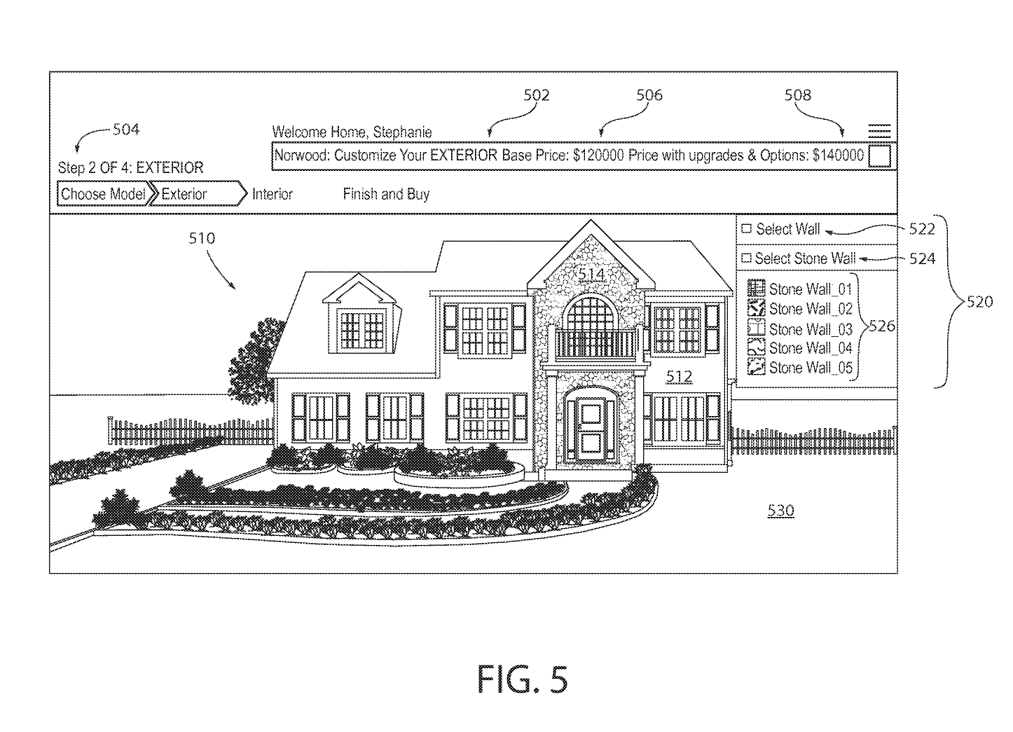

Turning now to FIG. 5, the user may be presented an exterior customization feature 500 that provides the option to customize certain exterior features of the home. It is contemplated that the user will be presented with a predetermined list of items that can be changed, customized, or swapped, insofar as is within the ready capability of the home builder or manufacturer. Even so, it is envisioned that the user could be provided with substantially unlimited control to modify the exterior (or even interior) of the home if the user is designing a completely custom home based on available options and models. As shown in FIG. 5, the exterior customization feature 500 greets the user with a personalization 502 that can include the user's name, home model type/name, and/or other personalized information. A workflow 504 is shown to graphically orient the user within the entire home design process. It is envisioned that the workflow 504 is an actionable item that the user can select to quickly move between the various phases of the home design process. Additionally, pricing information can be shown in various manners. In one example, the pricing information can include a base price 506 of the home (i.e., a predetermined original price of the home), and a current price 508 that includes the real-time price of the home with the user-selected upgrades and options. It is envisioned that the base price 506 may include only the home structure, or may be combined with other factors, such as real estate, landscaping, or other fees.

The exterior customization feature 500 further includes a virtual representation of the home exterior 510. The virtual representation uses 2D or 3D graphics and/or sound (such as an animated or video image, for example) to illustrate the home that the user is designing and customizing. Preferably, the virtual representation of the home exterior 510 is shown in an interactive, movable, three-dimensional computer graphics model that is a detailed virtual replica of the actual, intended home to be constructed. Preferably, the user can utilize the given computer input controls to rotate and translate the 3D model so as to view it from any angle or position. In this manner the user can alter the orientation of the virtual representation in three dimensions on the display screen. Optionally, the user can physically manipulate the structure of the home exterior 510 to add or remove features. Preferably, the system can further provide orthographic projections to project the three-dimensional home in two dimensions at standardized views. Going further, the user is provided with the option to customize certain features 512 of the home exterior 510. These customizations may include, but are not limited to, the type, style, design, number, placement, orientation, pattern, inclusion/exclusion, etc. of the roof, home siding, windows, shutters, doors, walkway, deck/patio, concrete features, front elevation features, optional rooms, garage bays, garage doors, entry way features, utility service placement (electricity, gas, water, solar, telecommunications, etc.) or other building exterior feature. The various options that a user is permitted to customize may be indicated by the GUI, such as by highlighting, outlines, color change, etc. This may occur when the user selects the particular item or even by hovering a cursor over the item (or a similar technique with a user's finger when using a touchscreen). The items could also be presented in a list, menu, or other text-based form.

In one example customization option, the user can be permitted to change a stone facing 514 on the front elevation of the home. The user can select the stone facing 514 and the GUI can present the user with a corresponding customization menu 520 that includes various options and sub-options, such as “Select Wall” 522 and “Select Stone Wall” 524. These options would change to be relevant to the particular item being customized. Upon choosing the wall to be customized, and selecting the “Select Stone Wall” 524 feature, a predetermined list of options 526 is presented to the user. The predetermined list of options 526 provides the user with, for example, different stone types, arrangements, finishes, and colors. A selection of any of these options will change the appearance of the stone facing 514 in the graphical virtual home exterior 510. In this manner, the user can quickly and easily experience what the various stone facing options will look like for their custom home. When the user is satisfied, the last-selected stone facing option will be considered the selected customization, or alternatively, the user may be asked to separately confirm the selection. As can be appreciated, there may be many possible customizations for the user to select. The corresponding customization menu 520, including the various options and sub-options, may act as a “checklist” for the user and sales company to help the user to understand the range of customizations available, and to ensure that the user does not accidentally forget to review and select those customizations. Additionally, the user could work directly from the customization menu 520, in a checklist type format, to experience all options.

The user may even be provided with the option to customize certain separate features 530 apart from the physical home, such as features of the landscaping about the home. For example, these separate customizations may include, but are not limited to, the type, style, design, number, placement, orientation, pattern, inclusion/exclusion, etc. of grass or other ground cover, walkways, sidewalks, gardens, trees, bushes, other plants, landscaping walls, retaining walls, driveways, fencing, drainage, lighting, decorative stones, boulders, mulch, sand, etc., children's playset, outbuildings, mailbox, swimming pools, hot tubs, sporting equipment, or other separate features. By allowing the user to customize separate features 530 apart from the physical home, the user can virtually experience their custom home within the context of a simulated real-world environment to provide a better expectation of what the finished home will ultimately look like. It is contemplated that some or all of the customize separate features 530 may be identified as purchase and non-purchase items, where purchase items are those selected by the user to be included in the finished home and included in the final home price (i.e., the current price 508) and non-purchase items are shown only to provide environmental context to the user but are excluded from the finished home and are excluded from the final home price. For example, purchase items may include grass and a driveway, while non-purchase items may include trees or bushes. Lastly, if the home is part of a planned housing development that includes a number of different housing lots (i.e., plots of real estate), another exterior customization may include the choice of the housing lot upon which the home is built. The system can be configured to provide a virtual representation of the housing development, in three dimensions, so that the user can better understand the “look and feel” of each lot. Example model homes may be provided to populate the sample housing development to provide context for the user's decision.

Additionally, although the current example is described with reference to a standalone single-family home, it is to be appreciated that the present application applies similarly to multi-unit buildings, such as condos and apartments in high-rise buildings. As can be appreciated, suitable exterior and interior customizations could be provided for these types of building. In this case, the apartment unit or condo unit may be selected as the building template, and the system can display a virtual representation, in three dimensions, of these building types with selectable options. For example, in the case of multi-unit apartments, whether one or more stories or even high-rise apartment buildings, similar exterior customizations might include allowing the user to choose the floor of the building where the apartment is situated, the actual location of the apartment on the chosen floor (including a simulated outside view from the various windows), and other options such as a balcony or even exterior window options, etc. Similar options might be provided for a condo, including whether the condo is attached to one or more other units, the location of the condo with reference to other attached units (especially in the case of row housing), and the location of the condo within a development.

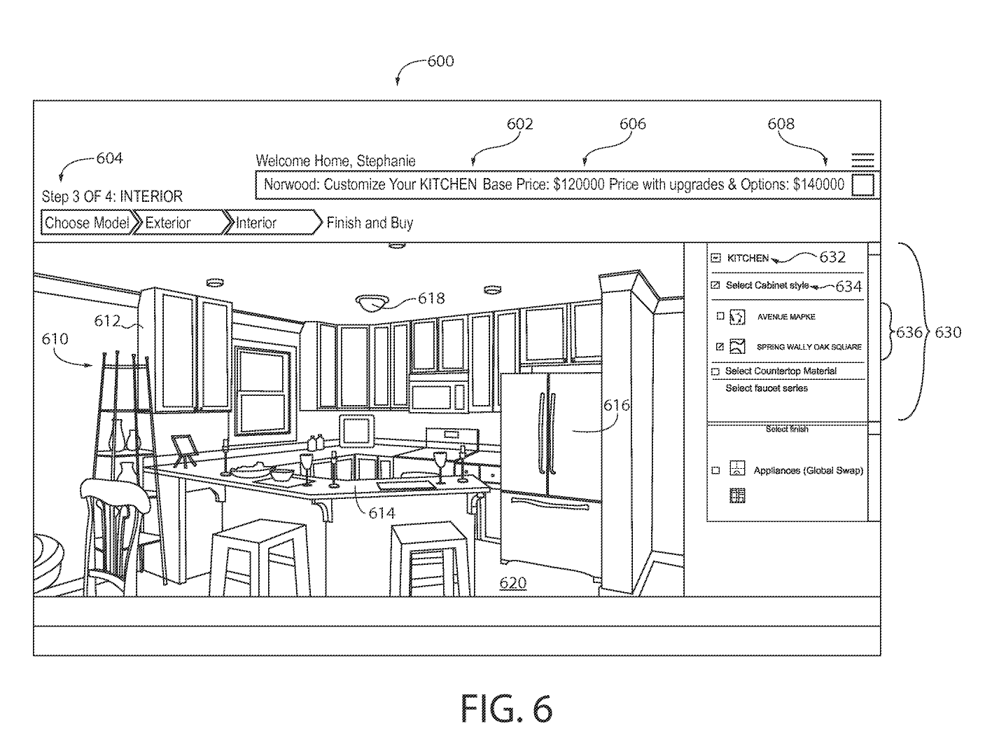

Once the user is done customizing the exterior of the home, the user may be presented an interior customization feature 600 as shown in FIG. 6 that provides the option to customize certain interior features of the home. The interior customization options can apply across all types of buildings. It is contemplated that the user will be presented with a predetermined list of items that can be changed, customized, or swapped, insofar as is within the ready capability of the home builder or manufacturer (although the user could be provided with substantially unlimited control over modifications). Keeping with a consistent user experience, the interior customization feature 600 greets the user with the same personalization 602, and a similar workflow 604 is shown to graphically orient the user within the entire home design process. Pricing information can still show the base price 606 of the home, and the current price 608 that now includes the real-time price of the home with the previously-selected exterior upgrades and options. While viewing the interior of the home, the homebuyer can customize many options. Some of the areas that the homebuyer may upgrade or change are throughout all rooms of the home, such as the Kitchen (including cabinets, countertops, faucets, appliances, lighting, structural additions such as an island, and more), Dining Room, Living Room, Master Bedroom, Master Bathroom (including shower and bathtub selections, faucets/fixtures, toilet, vanity style and countertop, and more), Guest Rooms, Guest Baths, Sitting Rooms, Utility Rooms (including washer, dryer, and storage cabinets), and more, depending on the model selected. Custom wall paint (including accent walls), flooring (including varying by room as desired), and other details such as crown molding or door handles may be updated and customized per room or overall, as a global change. The customer may further be provided with the option to add/change other features, as standalone items or part of packages, such as audio equipment (speakers (in-wall, surround), amplifiers, etc.), video equipment (TV, cable, antenna, satellite), lighting (interior or exterior), security equipment (window or door sensors, glass break detector, fire detector, CO detector, siren, motion detectors, video services, theft detection, temperature/flood detectors, keypads, control panels, remote controls, etc.), energy additions (solar power, geothermal, etc.), smart home controls, telecommunications (telephone, cable, fiber, networking, wireless networking, cellular phone/data, satellite, etc.), or other miscellaneous furnishings.

As before, the interior customization feature 600 includes a virtual representation of the home interior 610 using 2D or 3D graphics and/or sound (such as an animated or video image, for example) to illustrate the interior rooms that the user is designing and customizing. Preferably, the virtual representation of the home interior 610 is shown in an interactive, movable, three-dimensional computer graphics model that is a detailed virtual replica of each room in the intended home to be constructed. Preferably, the user can utilize the given computer input controls to rotate and translate the 3D model so as to view it from any angle or position. Most preferably, the user is provided with suitable input controls to enable the user to virtually “walk” through the various interior rooms to provide a close virtual representation of what the actual, finished home will appear like. It is contemplated that even rooms that are not customizable (e.g., a utility room) may still be shown so that the user has a full appreciation for the home. Additionally, there may be provided a predetermined list of rooms available to view and/or customized to quickly move the user to those desired rooms.

In the example of FIG. 6, the user is able to customize and design a kitchen. Generally, any or all of the selections made by the user can be displayed to scale on the kitchen model of the central monitor or touchscreen so that the user can instantly see what the resulting kitchen will look like. A similar process can be repeated for each room of the house. Here, the shown home interior 610 provides a virtual representation of the kitchen. Various items could be customizable, including but not limited to: cabinets 612, countertops 614, appliances 616, lighting 618, flooring 620, and other items/features. In the example virtual design suites 320 discussed herein, the basic kitchen plan may appear on the central monitor. If a user wishes to customize the cabinets 612, for example, then a selection of the cabinets can present various cabinet options and upgrades on the second monitor. The GUI can present the user with a corresponding customization menu 630 that includes various options and sub-options, such as “Kitchen” 632 and “Select Cabinet Style” 634. These options would change to be relevant to the particular item being customized. Upon choosing to customize the cabinets, and selecting the “Select Cabinet Style” 634 feature, a predetermined list of options 636 is presented to the user. The predetermined list of options 636 provides the user with, for example, different cabinet types, arrangements, finishes, and colors. A selection of any of these options will change the appearance of the cabinets 612 in the graphical virtual home interior 610. In this manner, the user can quickly and easily experience what the various cabinet options will look like for their custom kitchen. Next, the user can select possible sub-features of the cabinets, such as wood type, color, pulls, etc. The system may prompt the user to select these follow-on customizations.

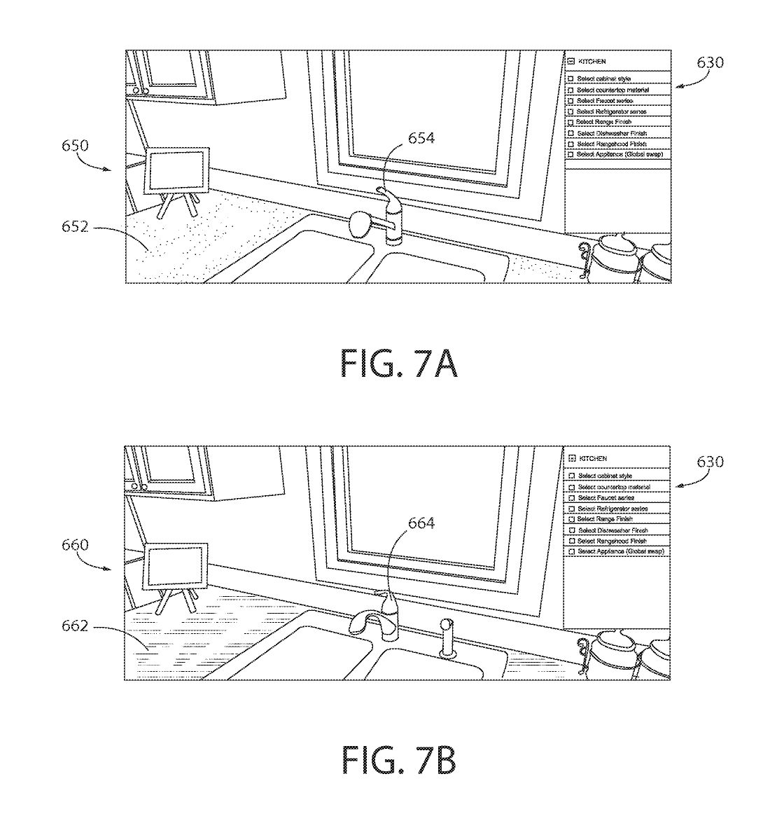

Turning now to FIGS. 7A-7B, detail views illustrate a portion of the kitchen with different customizations. In FIG. 7A, a first set 650 of customizations is shown regarding the kitchen sink area. The first set 650 includes a first countertop selection 652 and a first sink faucet selection 654. As can be seen, the first countertop is relatively darker in appearance, and the first sink faucet is a single handle design with removable spout. By contrast, in FIG. 7B, a second set 660 of customizations is shown regarding the same kitchen sink area. Here, a second countertop selection 662 is relatively lighter in color, and a second sink faucet selection 664 is a different style single handle design with a non-removable spout and separate side sprayer. The user can make these different selections using the corresponding customization menu 630 and sub-options therein. In so doing, the user can quickly and easily cross-compare each customization or swappable item. Additionally, it is possible for the system to make it easy for the user to compare and contrast different sets of customizations side by side. In one example, the system could simultaneously display both of FIGS. 7A and 7B on the same screen. This has the advantage of a direct side by side comparison, although the actual images will be reduced in size to fit on the screen. In another option, the system may allow the user to quickly switch between FIGS. 7A and 7B, so that each is provided with a full screen display. In the case of the virtual design suites 320 described herein with multiple displays, both of FIGS. 7A and 7B could be simultaneously displayed on separate screen, so that the user has a direct side by side comparison with full screen displays. A third screen could provide one or more customization menus to change the selected options shown in either or both of FIGS. 7A and 7B.

As noted herein, the overall system enables a real-time, dynamic pricing system that automatically updates the current price as the user makes all of the home customizations. Thus, the user can quickly and efficiently understand the actual price effect of each choice made during the home design process by viewing the current price 508 shown on the screen. In the kitchen sink example above, the user might select the first set 650 of customizations, including the first countertop selection 652 and first sink faucet selection 654. In order to enable the real-time pricing feature, the system architecture 200 leverages the common information database 212 (which ultimately obtains its pricing data from the ERP system 202, as previously described) to retrieve the corresponding product assemblies and associated cost information for each product assembly. Preferably, the product assembly includes both the engineering data and the pricing data. With this pricing data, the display can update the current price 508 to include the retrieved pricing data of the chosen part assemblies from the common information database 212. Thus, in this example, the first countertop selection 652 has a first price P1 and the first sink faucet selection 654 likewise has a first price P2. It is contemplated that this system occurs for each customized item of the home, so that the current price 508 is the sum of the house base price and all customizations (i.e., initial price+P1+P2). If the user then decides to choose the second countertop selection 662 with a second price P3 and the second sink faucet selection 664 with a second price P4, the current price 508 will automatically adjust (i.e., initial price+P3+P4). It is understood that the dynamic pricing happens similarly depending upon the actual matrix of selected options. Further, it is contemplated that the displayed pricing could further include one or more adjustment factors, which can be used to increase or decrease the modified price. For example, the adjustment factors could include additional fees, price reductions/discounts, taxes, etc. The adjustment factor(s) could be additions, subtractions, multipliers, etc. It is contemplated that the current price 508 can be an actionable item that the user could select to obtain a complete, detailed listing of all customizations that resulted in the current price 508. Similarly, the common information database 212 may contain the engineering drawings for display to the user as assemblies with an associated bill of materials, or the CAD system 204 can directly provide the graphics files to display the kitchen and sub-items (i.e., the countertop and sink faucet) with the bill of materials.

In summary, while the customer is designing the home via the graphical front-end, the Engineering resource system is constantly managing the structural configuration of the physical component parts while the ERP system is constantly updating its databases as to pricing, availability, production lead time, bill of materials, etc. Thus, real-time data including pricing data, product availability, a bill of materials, etc. is accessible to the builder/manufacturer and to the customer in a transparent manner so that they can quickly understand the ramifications of their design choices. Relevant information can then be displayed to the customer, in real-time, on a third or fourth touchscreen monitor. For example, an estimated final price (possibly including sub-price breakouts), lead time, delivery date, production schedule, and the like can be shown. Additionally, a detailed list of each modification can be provided as a change-list.

Once a customer is satisfied with the customized home design, the graphical front-end can provide various follow-on abilities. For example, it can allow the user to officially place an order for the home. Due to the large expense of a home purchase, the system can further direct the customer through one or more financing options, simulations, purchase agreements, etc. Additionally, if the home is to be built in an existing home development (or is part of an apartment complex), the graphical front-end can assist the user in lot selection or apartment location selection. Finally, because of the complex nature of purchasing a home, the system may utilize or require the intervention of an in-person or remote (such as through a video-feed) sales agent to complete or formalize the sales purchase.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A method of customizing a pre-designed tangible building to be physically constructed by a builder for a user, using a digital computer with a display, the method comprising the steps of:
receiving, using the digital computer, input from the user selecting a building template from a predetermined list of available building templates;
displaying, upon a graphical user interface of said display of the digital computer, a virtual representation of the selected building template and an associated initial price of the selected building template;
providing the selected building template with at least one interior or exterior feature that is customizable by the user;
receiving, using the digital computer, input from the user selecting a first customization option from a predetermined list of customization options that alters the selected building template with said at least one interior or exterior feature;
retrieving, using the digital computer, a first data element based upon computer-readable data stored in a Computer Aided Design (CAD) database that enables the digital computer to provide the user with a virtual representation of the selected first customization option;
displaying, upon the graphical user interface of said display, a modified virtual representation of the selected building template that includes said virtual representation of the first selected customization option;
retrieving, using the digital computer, a second data element based upon computer-readable data stored in an Enterprise Resource Planning (ERP) database that represents a first unit price of the selected first customization option;
displaying, upon the graphical user interface of said display, a modified price that includes the initial price of the selected building template and the first unit price of the selected first customization option,
wherein the modified virtual representation and the modified price of the selected building template are displayed substantially at the same time; and
assembling, using the digital computer, an engineering bill of materials to physically construct the pre-designed tangible building that includes the selected first customization option.

2. The method of customizing a pre-designed tangible building of claim 1,
wherein the first data element and second data element are each stored in a common information database that is separate from the ERP database and the CAD database, and
wherein the digital computer retrieves the first data element and second data element from the common information database.

3. The method of customizing a pre-designed tangible building of claim 2, wherein the first customization option comprises a single assembly, stored in the common information database, that includes both of the first data element and second data element.

4. The method of customizing a pre-designed tangible building of claim 1, wherein the first customization option comprises a collection of sub-components that each comprise a plurality of characteristics that are separately maintained by the ERP database.

5. The method of customizing a pre-designed tangible building of claim 4, wherein the ERP database provides a single value that is the first unit price based upon the plurality of characteristics of all of the sub-components of the first customization option.

6. The method of customizing a pre-designed tangible building of claim 5,
wherein the first unit price is stored in a common information database that is separate from the ERP database, and
wherein the step of retrieving the second data element comprises retrieving, using the digital computer, the first unit price from the common information database.

7. The method of customizing a pre-designed tangible building of claim 1, wherein the modified price further comprises at least one adjustment factor.

8. The method of customizing a pre-designed tangible building of claim 1, wherein the digital computer retrieves the first data element directly from the CAD database and the second data element directly from the ERP database.

9. The method of customizing a pre-designed tangible building of claim 1, further comprising the step of:
receiving, using the digital computer, input from the user to authorize the builder to physically construct the pre-designed tangible building including the first selected customization option.

10. The method of customizing a pre-designed tangible building of claim 1,
wherein the digital computer further comprises a human touch-sensitive input device, and
wherein the step of receiving input from the user comprises receiving input from the human touch-sensitive input device.

11. The method of customizing a pre-designed tangible building of claim 10, further comprising the steps of:
receiving, via the human touch-sensitive input device, a command from the user to alter an orientation of the modified virtual representation in three dimensions; and
displaying, upon the graphical user interface of said display, a different view of the modified virtual representation in three dimensions at the altered orientation.

12. The method of customizing a pre-designed tangible building of claim 1, further comprising the steps of:
receiving, using the digital computer, input from the user selecting a second customization option from another predetermined list of customization options to thereby further customize the selected building template;
retrieving, using the digital computer, a third data element based upon computer-readable data stored in a Computer Aided Design (CAD) database that enables the digital computer to provide a virtual representation of the selected second customization option;
displaying, upon the graphical user interface of said display, a second modified virtual representation of the selected building template that includes the virtual representations of both of the first and second selected customization options;
retrieving, using the digital computer, a fourth data element based upon computer-readable data stored in the Enterprise Resource Planning (ERP) database that represents a second unit price of the selected second customization option; and
displaying, upon the graphical user interface of said display, a second modified price of the selected building template that includes the initial price, the first unit price and the second unit price,
wherein the second modified virtual representation and the second modified price are displayed substantially at the same time.

13. The method of customizing a pre-designed tangible building of claim 1, wherein the computer-readable data stored in the CAD database and the ERP database is accessible via a networked computing environment.

14. The method of customizing a pre-designed tangible building of claim 1, wherein the at least one interior or exterior feature that is customizable by the user comprises at least one of an appliance, furniture, solar panels, and landscaping.

15. An interactive system for facilitating customization of a pre-designed tangible building to be physically constructed by a builder for a user, the system comprising:
a Computer Aided Design (CAD) database storing a plurality of available building templates and further storing a plurality of first data elements each corresponding to one of a plurality of customization options that will alter at least one interior or exterior feature of the available building templates;
an Enterprise Resource Planning (ERP) database storing computer-readable data that comprises an initial price for each of the plurality of available building templates and a plurality of second data elements corresponding to a unit price for each of the plurality of customization options;
a common information database distinct from and in communication with the ERP database and the CAD database, wherein the common information database stores computer-readable data that comprises a plurality of product assemblies with each product assembly corresponding to one of the plurality of customization options,
wherein each product assembly further comprises one of said first data element and one of said second data element; and
a tangible, interactive computer system operated by the user, comprising:
at least one digital processor;
at least one display connected to the at least one digital processor and capable of displaying a graphical user interface;
a user touch-sensitive input device connected to the at least one digital processor for manipulating the graphical user interface based upon inputs received from the user; and
a processor-readable storage device including instructions executable by the at least one digital processor to execute instructions for:
receiving, using the touch-sensitive input device, input from the user selecting a building template;
displaying, upon the graphical user interface of the display, a virtual representation in three dimensions of the selected building template and an associated initial price of the selected building template;
receiving, using the touch-sensitive input device, input from the user selecting one of said plurality of customization options;
receiving, from the common information database, a product assembly that corresponds to the selected customization option and includes associated first and second data elements,
wherein the first data element of each of the plurality of customization options comprises computer-readable data that enables the at least one digital processor to display in three dimensions a virtual representation of each customization option upon the at least one display;
displaying, upon the graphical user interface of the display, a modified virtual representation in three dimensions of the selected building template that includes said virtual representation of the selected customization option based upon said associated first data element; and
displaying, upon the graphical user interface of the display, a modified price that includes the initial price of the selected building template and a unit price of the selected customization option based upon said associated second data element.

16. The interactive system of claim 15, wherein the common information database is physically located at a different geographic location than the CAD database and ERP database, and is in communication with both of the CAD database and ERP database via a networked computing environment.

17. The interactive system of claim 15, wherein the tangible, interactive computer system can further execute instructions for:
assembling an engineering bill of materials to physically construct the tangible building that includes the selected customization option.

18. The interactive system of claim 17, wherein the first customization option comprises a collection of sub-components that each comprise a plurality of characteristics that are separately maintained by the ERP database, and
wherein the tangible, interactive computer system can further execute instructions for receiving, from the ERP database, the collection of sub-components of the first customization option to thereby assemble the engineering bill of materials.

19. The interactive system of claim 15, wherein the at least one display comprises at least two displays, and
wherein the tangible, interactive computer system can further execute instructions for displaying, on one display, the modified virtual representation in three dimensions of the selected building template that includes the selected customization option, and further displaying, on another display, information relating to the first and second data elements of the product assembly that corresponds to the selected customization option.

20. The interactive system of claim 15, wherein the tangible, interactive computer system can further execute instructions for:
receiving, via the user touch-sensitive input device, a command from the user to alter an orientation of the modified virtual representation in three dimensions; and
displaying, upon the graphical user interface of the display, a different view of the modified virtual representation in three dimensions at the altered orientation.

21. The interactive system of claim 15, wherein the modified price that is displayed upon the graphical user interface of the display further includes an adjustment factor.
